(19) United States
(12) Patent Application Publication
(10) Pub. No.: US 2002/0007622 A1
(43) Pub. Date: Jan. 24, 2002

(54) Harvester shaker pad

(76) Inventors: Christopher Compton, Chico, CA (US); Ira Compton, Chico, CA (US)

Correspondence Address: Christopher Compton, 2434 Dayton Road, Chico, CA, 95928, US

(21) Appl. No.: 09/911,026

(22) Filed: Jul. 20, 2001

Related U.S. Application Data
(60) Provisional application No. 60/220,415, filed on Jul. 24, 2000.

(51) Int. Cl. A01D 46/26; F28D 11/06

(52) U.S. Cl. 56/340.1; 165/84

(57) ABSTRACT

On tree shaking harvesters, shaker heads with padding engage tree trunks of nut and fruit trees and shake the trunks to dislodge the fruit/nuts. The invention disclosed is directed toward an improved pad or padding filler and cooling arrangement for the pads of a shaker machine/harvester. The pad is improved by having an improved filler material within a main chamber of the pad, the filler being ceramic material to supply body and help maintain a cool pad; and an improved cooling liquid circulation fitting is connected to the pad in one embodiment.

### CROSS REFERENCE TO RELATED APPLICATION(S)

A claim is hereby made to the earlier filing date of our pending U.S. Provisional Application number 60/220,415 filed Jul. 24, 2000 and which is herein incorporated by reference.

### BACKGROUND OF THE INVENTION

1. Field of the Invention

This invention relates to harvesters. More specifically to shaker pads/heads on nut and fruit tree shakers used in harvesting to shake tree trunks to dislodge the fruit. The invention is directed toward an improved pad filler and cooling arrangement for the pads of a shaker machine.

2. Description of the Related Prior Art

The majority of the related Prior art is in U.S. class 056. We are not aware of any prior art alone or in combination which can be said to teach or to fairly suggest the present invention.

### SUMMARY OF THE INVENTION

Incorporated herein by reference are the following U.S. Pat. Nos. 5,467,588; 5,385,006; 4,986,065; 4,932,195; 4,921,073; 4,893,458 and 4,757,674 all naming Ira Compton as inventor. U.S. Pat. No. 4,932,195 shows and describes many features, i.e., a tree shaker harvester, pads, pad mountings, coolant systems and circulation arrangements all aiding in the ready understanding of the instant invention.

The present invention is an improved main shaker pad of a tree shaking harvester, the pad improved by having the aspects of either: 1) an improved filler material within a main chamber of the pad, the filler being ceramic material to supply body and help cool the pad, and or 2) an improved cooling liquid circulation connection fitting to the pad. Improvements 1 and 2 are inventive and novel individually and combined with one another.

### BRIEF DESCRIPTION OF THE DRAWINGS

FIG. 1 shows an end of a shaker arm with shaker head of a shaker harvester, the padding and a coolant circulation system is also indicated for example.

FIG. 2 a shaker head main pad in cross section and having therein a filler of ceramic members and also having a fitting connected in one end and reaching internally deep in the central cavity of the pad.

FIG. 3 is an enlarged cross section of the fitting of FIG. 2.

### BEST MODES FOR CARRYING OUT THE INVENTION

The present invention from one possible viewpoint is an improved main shaker pad 12, the pad improved by having the aspects of: 1) an improved filler material within a main chamber 28 of the pad 12, the filler being ceramic material 30 to supply body and help cool or maintain cool the pad 12, and or 2) an improved cooling liquid circulation connection fitting 18 to the pad 12. Improvements 1 and 2 are inventive and novel individually and combined with one another. The pad 12 is filled and cooled by aspects 1) and 2) combined or when applied separately. “Filled” does not have to or necessarily mean “100 percent” in this disclosure. The pad 12 can be filled with cooling/lubricating liquid, or ceramic members, or ceramic members 30 with cooling and or lubricating liquid.

The pad 12 is to be used in opposing pairs on a tree trunk shaking harvester, one main pad 12 per each of two opposing shaker arms on a shaker harvester. “Main pad” 12 or “pad” 12 in this disclosure is referring to the elongate deformable pad comprising side walling and end walling, pad 12 which is primarily responsible for separating or cushioning the hard end of the shaker arm 10 from the tree, wherein the retaining sling 14 and slip pads 16 (if used), although rubbery thin sheet material, primarily are for differing functional reasons other than padding as explained in the herein incorporated patents.

The present pad which is generally cylindrical, is made of rubbery or pliable material, including an annular sidewall and two oppositely disposed end walls, the walls define an internal chamber 28 positioned to be in the area of the tree member during shaking, the pad 12 is sealed against unwanted leaking but includes a port 36 preferably having threads 34 thereabout and positioned in an end of the pad 12 so as to not be in the area of the tree member when the tree is grasp and the pad 12 is placed under high compression. The port 36 should be openable and closeable such as with a plug cooperative with the opening in the pad. Threaded walls about the port 36 with threaded walls on the plug function well. Typically the port 36 is a metal insert or tube having threads 34 in the inside bore, and molded or bonded into a hole through the end wall of the pad 12. The hollow chamber 28 is filled 20 to 100 percent with loose ceramic beads or pellets (ceramic members 30) in accordance with the present invention. The ceramic members 30 are in bead or pellet or granular form and loose so as to allow the pad 12 to flex or deform about the tree member when pressure is applied. The advantage of the ceramic material (members 30) over plastics, walnut shells and other pad fillers of the prior art is that it will hold-up better under the extreme high heat and pressures (compression) associated with such tree shaking. The ceramic members 30 also dissipate heat rapidly. The ceramic members 30 will not melt or fuse together into a hard clump. Clumps in the prior art pad fillers lead to pad 12 damage and tree damage. Examples of suitable ceramic members 30 include ceramic of numerous chemical make-ups including those from the chemical family of aluminosilicate for example only, but which is available and which functions well at a reasonable price. Also, for example, the ceramic members 30 are preferably round, or somewhat round (smooth or smooth cornered), although they don't have to be perfectly round in shape, the preferred round shape and smooth outer surface is so the ceramic members don't lock together too tightly and are able to move around and by one another for better allowing the pad 12 to deform against the tree member, and for reduced friction and the resultant heat. Suitable hard and smooth ceramic members 30 are available for purchase in the U.S., for example only, CARBO CERAMICS of Irving Tex. has a variety of suitable ceramics in bead-like form which are sold as proppants to the oil and gas drilling industry. These proppants will, as one example only, function well or in a superior manner as a harvester shaker pad filler. The ceramic members 30 can be put into the pad chamber 28 through the port 36, and the chamber 28 can also contain a liquid lubricant such as oil, water soluble oil, silicone lubricant or any other suitable lubricant, liquid or powder, which will reduce friction and thus heat between the ceramic members 30 and the ceramic members 30 and pad chamber walls. The lubricant can also serve as a coolant or a coolant can serve as a lubricant. The coolant can be primarily water, being environmentally safe, and may contain soap, oil or the like additive to provide some lubricating aspects. The ceramic members 30 can be in a wide variety of sizes such as for example in the range of fine sand on upward to as large as will fit through the open port 36 in the end of the pad 12. While ceramic balls (members) 1.5 inches in diameter or larger (example only) might function well, typically the port 36 opening is smaller than that and prevents the application of such large members. Ceramic members 30 which are small 1-4 millimeters for example only, are available as proppants and will function well, as will ceramic beads in the size range of between about ⅛ and ½ inch in diameter. Ceramic(s) are commonly defined as clay or similar material treated by firing.

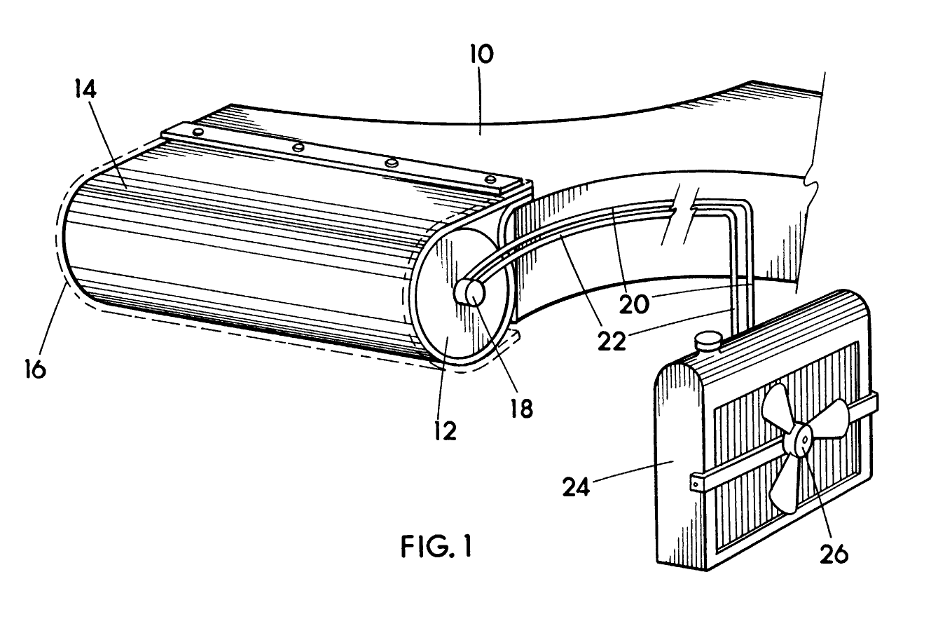

FIG. 1 is a view of a main pad or “pad” 10 mounted on the end of a shaker arm 10 of a shaker machine (machine not shown), and shown attached by a retaining sling 14. In broken lines is shown a slip pad 16. Secured removably in the port 36 of the pad is a fluid circulation fitting 18 having an inlet tube 20 and outlet tube 22 connected thereto and each connected to a heat exchanger 24 (heat remover) which in this example is an engine radiator such as the engine cooling radiator with cooling fan 26 of the shaker harvester machine. In this example the engine liquid coolant which preferably also includes lubricating qualities cools the shaker harvester main engine and is also circulated through the chamber 28 of the pad 12 to help cool the pad 12 and filler material (ceramics or ceramic members/beads). A fluid pump or just the engine water pump can be used to force fluid flow.

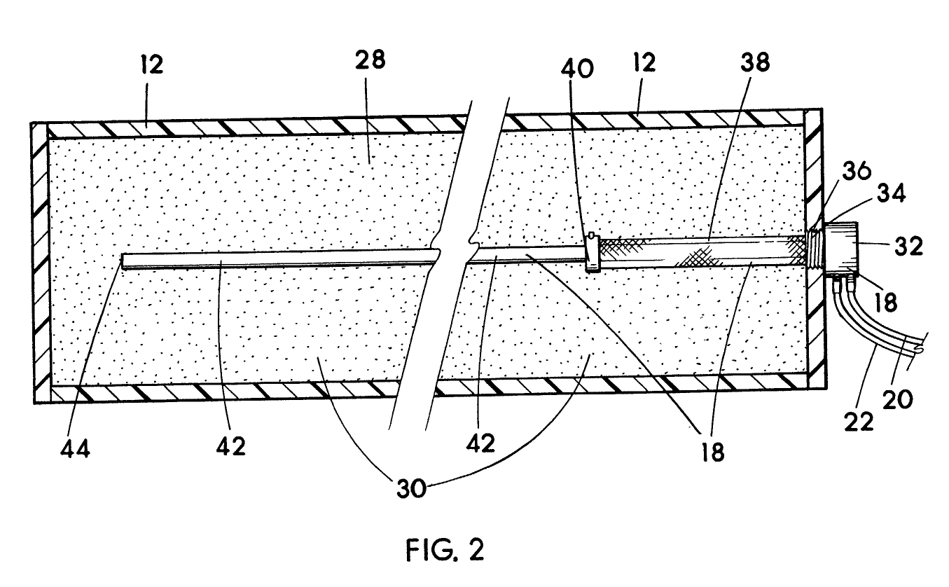

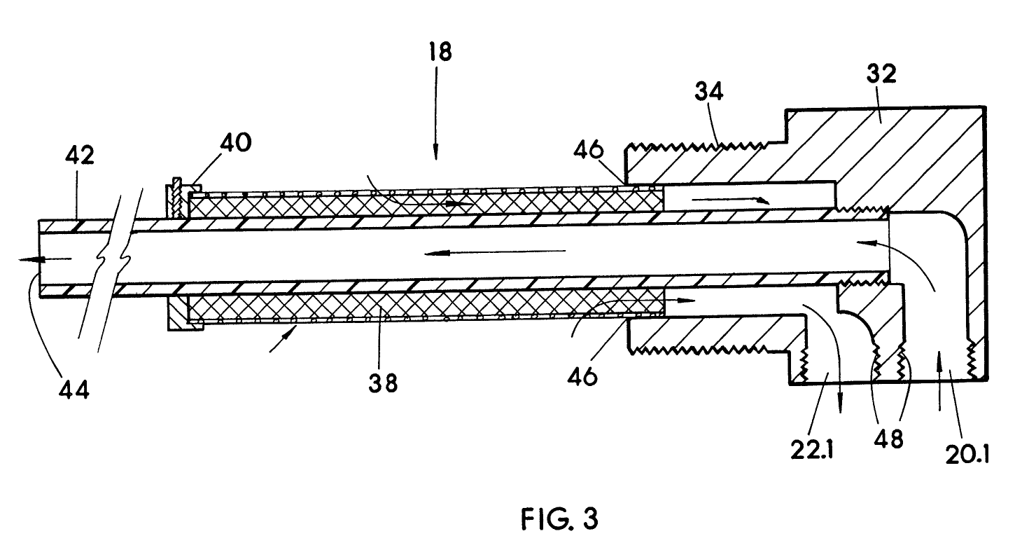

FIG. 2 is a cross sectional view of the pad 12 of FIG. 1 showing the chamber 28 filled with ceramic members or beads 30, and with the circulation fitting 18 having a body 32 with annular threaded portion threadably engaged with the threaded port wall of the pad port 36. The circulation fitting 18 includes an attached inlet tube 20 attached to body port 20.1 with threads 48 bringing coolant to the pad 12 to be directed through an elongate output tube 22 attached to body port 22.1 with threads 48 of the fitting 18 and dispensed into the chamber 28 at an point near the far end of the pad 12 by flexible tube 42 open end 44 away from the fitting 18 wherein the fluid (or cool air) travels a substantial distance back through the filler and along the pad walls picking up heat. The fluid travels due to pressure toward the fitting 18 body 32 picking up heat on its way and then to pass through a screen 38 or like excluder 38 for excluding the escape of the filler (ceramic members or beads). The fluid passes through the excluder 38 and enters an outlet area of the body 32 and connected outlet tube to travel back to the heat exchanger 24 (radiator) to release at least some of the heat picked-up in the pad 12 before being sent back to the pad 12 via traveling down the inlet tubing 20 in a continuous circulation or flow. Various materials can be used to structure the circulation fitting 18 and to help avoid crushing a flexible material hose or tubing 42 with open fluid output end 44 in the area where the pad 12 deforms under compression against the tree is preferred. FIG. 3 is a cross sectional view for example of a circulation fitting 18 in accordance with the invention and showing that the screen or excluder 38 can be removably retained on the elongate output tube inside the pad 12 and attached to the body 32, a collar and set-screw 40 are shown allowing servicing or replacement of the screen 38. A seal 46 of rubbery material or simply a tight fit is indicated a where the screen excluder engages a fitting such as the body 32 or 40.

For the sake of clarity, the present invention is an improved main shaker pad 12, the pad 12 improved by having the aspects of: 1) an improved filler material within a main chamber 28 of the pad 12, the filler being ceramic material members 30 to supply body and help keep the pad relatively cool, the ceramic member material 30 can be used in a sealed (plug installed in port) pad 12 not having any circulation arrangement but possibly having a fluid lubricant liquid or powder sealed in the chamber 28 therewith; and 2) an improved cooling liquid circulation connection fitting 18 to the pad 12 as herein described and shown which can be used with the ceramic filler material or any other suitable filler or no filler other than the coolant and or lubricant. Improvements 1 and 2 are inventive and novel individually, and combined with one another. The pad 12 is filled and cooled by aspects 1) and 2) combined or when applied separately.

Although we have very specifically described the preferred structures and methods of the invention, it should be understood that the specific details are given for example and are intended to illustrate the invention and not to limit the invention and aspects thereof. Changes in the specific structures/methods described may be made without departing from the scope of the invention, and therefore it should be understood that the scope of the invention is not to be unreasonably limited by the specification and drawings given for example.

We claim:

1. A method of cooling a shaker pad of a tree shaking harvester, said shaker pad having a filler of ceramic members within said pad, said shaker pad retained on a distal end of a shaker arm of the tree shaking harvester, comprising the steps of:
coursing a coolant in a circulatory system through said shaker pad and ceramic members whereat said coolant absorbs heat from said shaker pad and ceramic members;
coursing said coolant from said shaker pad and ceramic members through a heat exchanger positioned generally remote of said shaker pad and ceramic members whereat at least part of the absorbed heat is expelled from said coolant.

2. The method according to claim 1 wherein said coolant is used in a liquid form and is coursed through said ceramic members and a screen excluding passage of said ceramic members through said screen.

3. The method according to claim 2 wherein said coolant is primarily water.

4. The method according to claim 1 wherein said coursing of said coolant is caused by heat convention flow.

5. The method according to claim 3 wherein said coursing of said coolant is caused by mechanical pumping of said coolant; and said coolant is lubricating between said ceramic members.

6. The method according to claim 5 wherein said circulatory system includes connecting inlet tubing carrying inlet coolant and connecting outlet tubing carrying outlet coolant to said shaker pad utilizing a fitting connecting to a port in said shaker pad, and said fitting having an inlet port connected to said inlet tubing, and said fitting having an outlet port connected to said outlet tubing, said screen is supported by said fitting.

7. A shaker pad of a tree shaking harvester, said shaker pad comprising a body having an internal chamber, said chamber having a filler of ceramic members.

8. An improved shaker pad of a tree shaking harvester, said shaker pad comprising side walling and end walling defining a body having an internal chamber, said chamber having a filler therein,
wherein the improvement comprises
said filler is primarily of ceramic material.

9. An improved shaker pad according to claim 8 wherein said ceramic material comprises a plurality of ceramic members.

10. An improved shaker pad according to claim 9 wherein said ceramic members are ceramic beads.

11. An improved shaker pad according to claim 9 wherein said ceramic beads are lubricated.

12. An improved shaker pad according to claim 10 wherein said ceramic beads at least in part comprise aluminosilicate.

13. An improved shaker pad according to claim 10 wherein said shaker pad is flexible.

14. An improved shaker pad according to claim 11 wherein said shaker pad has a thread containing port in the end walling, the port leading into said chamber.

15. An improved shaker pad according to claim 14 wherein said shaker pad is used in pairs of said shaker pad in opposing arrangement.

16. An improved shaker pad according to claim 14 wherein said port is connected to a fitting having a fluid circulating tubing structure connected to the fitting and directing a coolant into and out of said chamber.

17. An improved shaker pad according to claim 10 wherein said coolant has lubricating properties.

18. An improved shaker pad according to claim 17 wherein said coolant is water based.

19. An improved shaker pad according to claim 18 wherein said fitting includes a flexible tube extending into said chamber.

20. An improved shaker pad according to claim 19 wherein said threads comprise a metal insert in the end walling of said pad; said pad is a main pad retained on a shaker arm by a retainer pad; a slip pad is positioned over said retainer pad, and fluid having cooling and lubricating properties is deposited at least between said retainer pad and said slip pad.
